(19) United States
(12) Patent Application Publication
(10) Pub. No.: US 2026/0129378 A1
(43) Pub. Date: May 7, 2026

(54) BONE CONDUCTION HEARING AID DEVICES

(71) Applicant: SHENZHEN SHOKZHEAR CO., LTD., Shenzhen (CN)

(72) Inventor: Huifang TANG, Shenzhen (CN)

(73) Assignee: SHENZHEN SHOKZHEAR CO., LTD., Shenzhen (CN)

(21) Appl. No.: 19/436,160

(22) Filed: Dec. 30, 2025

Related U.S. Application Data
(63) Continuation of application No. PCT/CN2024/096851, filed on May 31, 2024.

(51) Int. Cl. H04R 25/00; H04R 1/10

(52) U.S. Cl. CPC H04R 25/606; H04R 1/1083; H04R 25/405; H04R 25/607; H04R 2225/0213; H04R 2460/01; H04R 2460/13

(57) ABSTRACT

The present disclosure provides a bone conduction hearing aid device, including: a support structure including a rear hanging part 11, ear hanging parts, first mounting parts, and second mounting parts 14, wherein two ends of the rear hanging part 11 are respectively connected to one first mounting part, and each of the first mounting parts 13 is connected to one second mounting part via one ear hanging part; a speaker mounted in the second mounting part, wherein the speaker is configured to play a hearing aid sound signal; a plurality of microphones disposed on the connecting side surface, wherein the plurality of microphones are configured to receive a sound signal and convert the sound signal into an electric signal.

### CROSS-REFERENCE TO RELATED APPLICATIONS

This application is a Continuation of International Application No. PCT/CN2024/096851, filed on May 31, 2024, the contents of which are incorporated herein by reference.

### TECHNICAL FIELD

The present disclosure generally relates to the field of acoustics, and in particular, to a bone conduction hearing aid device.

### BACKGROUND

A bone conduction hearing aid device is a device that utilizes bone conduction to assist hearing-impaired users in perceiving sound, wherein the microphone, as a component for capturing ambient sound, plays a critical role. The performance of the microphone in capturing sound directly determines the auditory experience, safety, and social interaction capabilities of the hearing-impaired users. While the bone conduction hearing aid device transmits external sound to the user through vibration, the vibration of the housing introduces a certain degree of interference to the microphone's sound pickup, thereby adversely affecting its performance.

### SUMMARY

One or more embodiments of the present disclosure provide a bone conduction hearing aid device, which is used to solve the problem of interference of housing vibration on microphone sound pickup.

In one embodiment, a bone conduction hearing aid device is provided, including:
a support structure including a rear hanging part, ear hanging parts, first mounting parts, and second mounting parts, wherein two ends of the rear hanging part are respectively connected to one first mounting part, and each of the first mounting parts is connected to one second mounting part via one ear hanging part; the rear hanging part is configured to be worn on a rear side of a user's head, and each of the ear hanging parts is configured to be worn on an upper part of the user's ear; each of the first mounting parts includes an inner side surface facing the user when worn, an outer side surface facing away from the user when worn, and a connecting side surface connecting the inner side surface and the outer side surface;
a speaker mounted in the second mounting part, wherein the speaker is configured to play a hearing aid sound signal;
a plurality of microphones disposed on the connecting side surface, wherein the plurality of microphones are configured to receive a sound signal and convert the sound signal into an electric signal.

In one embodiment, the plurality of microphones include at least a first microphone and a second microphone, and the first microphone and the second microphone are spaced apart.

In one embodiment, the connecting side surface includes an upper connecting side surface facing upward when worn and a lower connecting side surface facing downward or rearward when worn, and the first microphone and the second microphone are disposed on the lower connecting side surface.

In one embodiment, the lower connecting side surface includes a first lower connecting side surface and a second lower connecting side surface having an angle therebetween, an angle between the first lower connecting side surface and the upper connecting side surface is less than an angle between the second lower connecting side surface and the upper connecting side surface, the second lower connecting side surface faces away from the second mounting part, the first microphone is disposed on the first lower connecting side surface, and the second microphone is disposed on the second lower connecting side surface.

In one embodiment, the lower connecting side surface includes a first lower connecting side surface and a second lower connecting side surface having an angle therebetween, and the first microphone and the second microphone are disposed on the first lower connecting side surface, or the first microphone and the second microphone are disposed on the second lower connecting side surface.

In one embodiment, a symmetry plane is defined between the outer side surface and the inner side surface, and the first microphone and the second microphone are located outside the symmetry plane and/or on the symmetry plane.

In one embodiment, the first microphone and/or the second microphone located outside the symmetry plane are closer to the symmetry plane than the outer side surface.

In one embodiment, a distance between the first microphone and the symmetry plane and/or a distance between the second microphone and the symmetry plane are in a range of 0 mm to 5 mm.

In one embodiment, a first projection line of a connection line between the first microphone and the second microphone projected onto the outer side surface intersects with a second projection line of the upper connecting side surface projected onto the outer side surface.

In one embodiment, an angle between the first projection line and the second projection line is in a range of 0° to 60°.

In one embodiment, the angle between the first projection line and the second projection line is in a range of 0° to 30°.

In one embodiment, an angle between the first projection line and the second projection line is in a range of 5° to 65°.

In one embodiment, the angle between the first projection line and the second projection line is in a range of 5° to 35°.

In one embodiment, the first projection line is parallel to a horizontal line when the bone conduction hearing aid device is worn.

In one embodiment, a distance between the first microphone and the second microphone is in a range of 2 mm to 45 mm.

In one embodiment, a bone conduction hearing aid device is provided, including:
a support structure including a rear hanging part, ear hanging parts, first mounting parts, and second mounting parts, wherein two ends of the rear hanging part are respectively connected to one first mounting part, and each of the first mounting parts is connected to one second mounting part via one ear hanging part; the rear hanging part is configured to be worn on a rear side of a user's head, and each of the ear hanging parts is configured to be worn on an upper part of the user's ear; each of the first mounting parts includes an inner side surface facing the user when worn, an outer side surface facing away from the user when worn, and a connecting side surface connecting the inner side surface and the outer side surface.
a speaker mounted in the second mounting part, wherein the speaker is configured to play a hearing aid sound signal;
a plurality of microphones disposed on the connecting side surface and the outer side surface, wherein the plurality of microphones are configured to receive a sound signal and convert the sound signal into an electric signal.

In one embodiment, the plurality of microphones include at least a first microphone and a second microphone, and the first microphone and the second microphone are spaced apart.

In one embodiment, the connecting side surface includes an upper connecting side surface facing upward when worn and a lower connecting side surface facing downward or rearward when worn, the first microphone is disposed on the lower connecting side surface, and the second microphone is disposed on the outer side surface.

In one embodiment, the lower connecting side surface includes a first lower connecting side surface and a second lower connecting side surface having an angle therebetween, an angle between the first lower connecting side surface and the upper connecting side surface is less than an angle between the second lower connecting side surface and the upper connecting side surface, the second lower connecting side surface faces away from the second mounting part, and the first microphone is disposed on the second lower connecting side surface.

In one embodiment, a symmetry plane is defined between the outer side surface and the inner side surface, and the first microphone is located outside the symmetry plane or on the symmetry plane.

In one embodiment, the first microphone is closer to the symmetry plane than the outer side surface.

In one embodiment, a distance between the first microphone and the symmetry plane is in a range of 0 mm to 5 mm.

In one embodiment, a first projection line of a connection line between the first microphone and the second microphone projected onto the outer side surface intersects with a second projection line of the upper connecting side surface projected onto the outer side surface.

In one embodiment, an angle between the first projection line and the second projection line is in a range of +60° to −60°, +60° to −30°, 0° to 30°, or 5° to 35°.

In one embodiment, the first projection line is parallel to a horizontal line when the bone conduction hearing aid device is worn.

In one embodiment, a distance between the first microphone and the second microphone is in a range of 2 mm to 30 mm.

In one embodiment, a bone conduction hearing aid device is provided, including:
a support structure including a rear hanging part, ear hanging parts, first mounting parts, and second mounting parts, wherein two ends of the rear hanging part are respectively connected to one first mounting part, and each of the first mounting part is connected to one second mounting part via one ear hanging part; the rear hanging part is configured to be worn on a rear side of a user's head, and each of the ear hanging parts is configured to be worn on an upper part of the user's ear; each of the first mounting parts includes an inner side surface facing the user when worn, an outer side surface facing away from the user when worn, and a connecting side surface connecting the inner side surface and the outer side surface.
a speaker mounted in the second mounting part, wherein the speaker is configured to play a hearing aid sound signal.
a plurality of microphones disposed on the outer side surface, wherein the plurality of microphones are located on a straight line, and the straight line is parallel to the vibration axis of the first mounting part; and the plurality of microphones are configured to receive a sound signal and convert the sound signal into an electric signal.

In one embodiment, a symmetry plane is defined between the outer side surface and the inner side surface, and the straight line is parallel to the symmetry plane.

In one embodiment, the connecting side surface includes an upper connecting side surface facing upward when worn and a lower connecting side surface facing downward or rearward when worn, and a first projection line of the straight line projected onto the outer side surface intersects a second projection line of the upper connecting side surface projected onto the outer side surface.

In one embodiment, an angle between the first projection line and the second projection line is in a range of +60° to −60°.

In one embodiment, the angle between the first projection line and the second projection line is in a range of +60° to −30°.

In one embodiment, the angle between the first projection line and the second projection line is in a range of +30° to −30°.

In one embodiment, the angle between the first projection line and the second projection line is in a range of 0° to −30° or 5° to 35°.

In one embodiment, the plurality of microphones include at least a first microphone and a second microphone, and a distance between the first microphone and the second microphone is in a range of 2 mm to 30 mm.

In the bone conduction hearing aid device according to the above embodiments, when the bone conduction hearing aid device provides acoustic feedback to a hearing-impaired patient, vibration from the speaker is inevitably transmitted to the first mounting part. The vibration of the first mounting part affects sound pickup by the microphone on the first mounting part, resulting in noise in the sound pickup and increasing the possibility of howling. During the vibration of the first mounting part, the outer side surface and the inner side surface of the first mounting part vibrate and generate sound waves with identical amplitude and frequency but opposite phase, thereby forming a dipole pair. An effect of sound wave “cancellation” is formed on the connecting side surface between the outer side surface and the inner side surface. Disposing the plurality of microphones on the connecting side surface of the first mounting part can reduce the interference of the vibration of the first mounting part on sound pickup by the microphones and improve the noise reduction effect of sound pickup by the microphones.

### BRIEF DESCRIPTION OF THE DRAWINGS

FIG. 1 is a schematic structural diagram of a bone conduction hearing aid device according to one embodiment.

FIG. 2 is a schematic diagram of a partial structure of a bone conduction hearing aid device according to one embodiment.

FIG. 3 is a schematic diagram of a partial structure of a bone conduction hearing aid device according to one embodiment.

FIG. 4 is a schematic diagram of a bone conduction hearing aid device when worn according to one embodiment.

FIG. 5 is a side view of a bone conduction hearing aid device according to one embodiment.

FIG. 6 is a schematic structural diagram of a bone conduction hearing aid device according to one embodiment.

FIG. 7 is a schematic structural diagram of a bone conduction hearing aid device according to one embodiment.

FIG. 8 is a schematic structural diagram of a bone conduction hearing aid device according to one embodiment.

FIG. 9 is a schematic structural diagram of a bone conduction hearing aid device according to one embodiment.

FIG. 10 is a side view of a bone conduction hearing aid device according to one embodiment.

FIG. 11 is a schematic structural diagram of a bone conduction hearing aid device according to one embodiment.

The reference signs are as follows:
1—support structure, 11—rear hanging part, 12—ear hanging part, 13—first mounting part, 131—inner side surface, 132—outer side surface, 133—connecting side surface, 1331—upper connecting side surface, 1332—lower connecting side surface, 13321—first lower connecting side surface, 13322—second lower connecting side surface, 1333—front connecting side surface, 14—second mounting part;
2—speaker;
3—microphone, 31—first microphone, 32—second microphone;
P—symmetry plane, X—vibration axis.

### DETAILED DESCRIPTION

The present disclosure is further described in detail below through specific embodiments with reference to the accompanying drawings. Similar elements in different embodiments adopt associated similar element reference numbers. In the following embodiments, numerous details are provided to facilitate a deeper understanding of the present application. However, a person skilled in the art may readily recognize that some of the features may be omitted under different circumstances, or may be replaced by other elements, materials, or manners. In certain circumstances, some operations related to the present application are not explicitly illustrated or described in the present disclosure. This omission is intended to prevent the core aspects of the present application from being obscured by excessive detail. For a person skilled in the art, a detailed description of such related operations is not necessary, as they may fully comprehend these operations based on the descriptions provided in the present disclosure and their general technical knowledge in the field.

In addition, the features, operations, or characteristics described in the present disclosure may be combined in any appropriate manner to form a plurality of embodiments. Meanwhile, the steps or actions in the method description may also be sequentially exchanged or adjusted in a manner obvious to a person skilled in the art. Therefore, the various sequences in the present disclosure and the accompanying drawings are only for clearly describing a certain embodiment, and do not mean that they are necessary sequences, unless otherwise specified that a certain sequence must be followed.

The serial numbers themselves for the parts in the present disclosure, such as “first”, “second”, etc., are only used to distinguish the described objects, and do not have any sequential or technical meaning. The “connection” and “coupling” mentioned in the present application, unless otherwise specified, include direct and indirect connection (coupling).

In one embodiment, a bone conduction hearing aid device is provided. The present bone conduction hearing aid device is a head-mounted device configured to be worn over both ears and the head of a hearing-impaired user. The head-mounted design provides enhanced wearing stability, reducing the risk of accidental dislodgement. Furthermore, the hearing-impaired user may wear the bone conduction hearing aid device during physical activities. The bone conduction hearing aid device redesigns the position of a microphone. The microphone is disposed on a connecting side surface between an outer side surface and an inner side surface of a mounting part. When vibrations of the outer side surface and the inner side surface of the mounting part are transmitted to the connecting side surface in the middle, the vibrations cancel each other out. In other words, the vibration interference received by the microphone located on the connecting side surface is much less than the vibration interference at a position on the outer side surface or the inner side surface. The redesigned microphone position can significantly reduce vibration interference and improve the noise reduction effect of sound pickup.

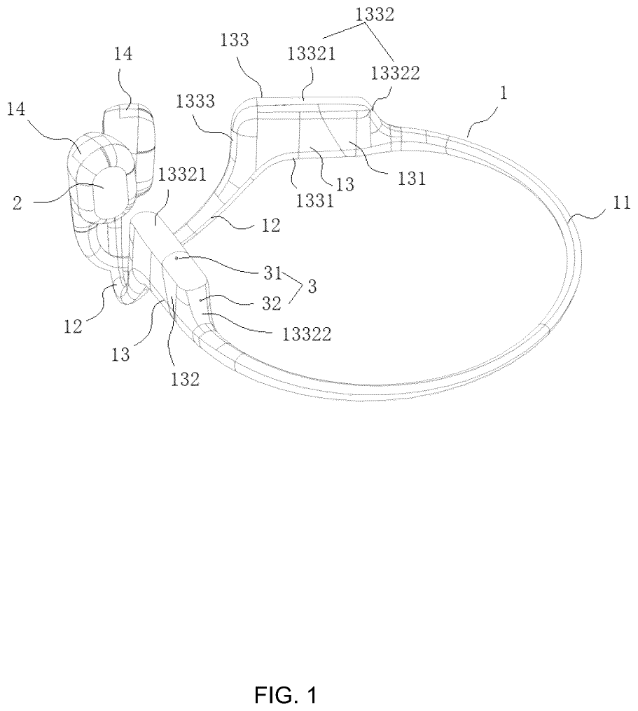

Please refer to FIG. 1. A bone conduction hearing aid device of the present embodiment mainly includes a support structure 1, a speaker 2, and a plurality of microphones 3.

The support structure 1 includes the rear hanging part 11, ear hanging parts 12, first mounting parts 13, and second mounting parts 14. A count of the rear hanging part 11 is one, while a count of the ear hanging parts 12, the first mounting parts 13, and the second mounting parts 14 is two each. Two ends of the rear hanging part 11 are respectively connected to one first mounting part 13, and each of the first mounting parts 13 is connected to one second mounting part 14 via one ear hanging part 12. That is, one second mounting part 14, one ear hanging part 12, one first mounting part 13, the rear hanging part 11, another first mounting part 13, another ear hanging part 12, and another second mounting part 14 are sequentially connected. The ear hanging parts 12, the first mounting parts 13, and the second mounting parts 14 connected to the two ends of the rear hanging part 11 may be symmetrically disposed. The rear hanging part 11 is an arc-shaped structure adapted to a human head. The rear hanging part 11 is configured to be worn on a rear side of a user's (a hearing-impaired patient's) head. Each of the ear hanging parts 12 is an arc-shaped structure adapted to an outer ear auricle. Each of the ear hanging parts 12 is configured to be worn on an upper part of the user's ear. Each of the first mounting parts 13 is configured to be worn at an ear canal opening of the user.

The support structure 1 may be integrated as a whole. For example, the support structure 1 is an integrated structure made of silicone or other materials. The integrated support structure 1 has better connection stability and can form a seamless appearance, which is more aesthetically pleasing.

In other embodiments, a part of the support structure 1 is an integrated structure, and another part is fixed by connection. For example, the ear hanging parts 12, the first mounting parts 13, and the second mounting parts 14 are an integrated structure, and the rear hanging part 11 is fixedly connected to the first mounting parts 13 by plugging, threaded connection, or the like. Such a configuration allows the support structure 1 to be provided with rear hanging parts 11 of different lengths and curvatures to adapt to users with different head sizes.

In the present embodiment, the speaker 2 is mounted in the second mounting part 14. A part of the speaker 2 is exposed from the second mounting part 14. The exposed part of the speaker 2 is configured to contact an ear or an edge position of the ear of the user when worn. The speaker 2 is configured to play a hearing aid sound signal, that is, the speaker 2 is configured to play a sound. Each second mounting part 14 is mounted with one speaker 2, which may achieve audio playback of left and right channels.

The plurality of microphones 3 are configured to receive a sound signal and convert the sound signal into an electric signal. The plurality of microphones 3 are mainly configured to collect external sounds for the user.

Each first mounting part 13 is provided with the plurality of microphones 3. One first mounting part 13 is preferably provided with two microphones 3. The dual microphones 3 can form a certain sound pickup difference, which is convenient for eliminating interference. In addition, the dual microphones 3 can also achieve directional sound pickup, thereby improving the sound pickup effect. In other embodiments, one first mounting part 13 may also be provided with three or more microphones 3.

It should be noted that, in the present application, the microphone 3 being disposed on a side surface of the first mounting part 13 means that a sound pickup hole corresponding to the microphone 3 is provided on the side surface of the first mounting part 13. The microphone 3 is located inside the first mounting part 13 and close to the sound pickup hole.

The first mounting part 13 is approximately a cuboid structure. The first mounting part 13 has an accommodation cavity inside. The accommodation cavity in the first mounting part 13 may be configured to mount components such as a circuit board, a battery, etc. Certainly, components such as the circuit board and the battery may also be mounted in other parts of the support structure 1, for example, in the second mounting part 14 or the rear hanging part 11.

The first mounting part 13 includes an inner side surface 131, an outer side surface 132, and a connecting side surface 133. When the bone conduction hearing aid device is worn, the inner side surface 131 faces the user, the inner side surface 131 may be attached to the user's head, or may maintain a certain gap with the head, and the outer side surface 132 faces away from the user. The outer side surface 132 and the inner side surface 131 may be disposed parallel to each other. The connecting side surface 133 connects the inner side surface 131 and the outer side surface 132. The connecting side surface 133, the inner side surface 131, and the outer side surface 132 form an outer surface of the first mounting part 13. The rear hanging part 11 and the ear hanging part 12 are respectively connected to the connecting side surface 133.

The first mounting part 13 is a flat structure. The flat structure may make the first mounting part 13 more conform to the user's head when the bone conduction hearing aid device is worn. At the same time, the flat structure may reduce a thickness of the first mounting part 13, so that the first mounting part 13 fits the user's head more closely when worn, without being too protruding, which is more aesthetically pleasing. A distance between the outer side surface 132 and the inner side surface 131 is less than a length and a width of the outer side surface 132 and the inner side surface 131. The connecting side surface 133 between the outer side surface 132 and the inner side surface 131 may also be referred to as a narrow surface.

The connecting side surface 133 includes an upper connecting side surface 1331 and a lower connecting side surface 1332. When worn, the upper connecting side surface 1331 faces upward, and the lower connecting side surface 1332 faces downward. Certainly, the upper connecting side surface 1331 and the lower connecting side surface 1332 may face vertically upward or downward, or may face obliquely upward or obliquely downward. The lower connecting side surface 1332 may also face rearward or obliquely rearward.

The connecting side surface 133 further includes a front connecting side surface 1333. When worn, the front connecting side surface 1333 faces a front of the user. A rear connecting side surface of the connecting side surface 133 is connected to the rear hanging part 11. The rear hanging part 11 covers the rear connecting side surface of the connecting side surface 133. The ear hanging part 12 is connected to the upper connecting side surface 1331. The ear hanging part 12 covers a part of the upper connecting side surface 1331.

The upper connecting side surface 1331 is a plane. The lower connecting side surface 1332 includes two planes. The lower connecting side surface 1332 includes a first lower connecting side surface 13321 and a second lower connecting side surface 13322. The first lower connecting side surface 13321 and the upper connecting side surface 1331 may be parallel or approximately parallel. An angle is formed between the first lower connecting side surface 13321 and the second lower connecting side surface 13322. An angle between the first lower connecting side surface 13321 and the upper connecting side surface 1331 is less than an angle between the second lower connecting side surface 13322 and the upper connecting side surface 1331, that is, the second lower connecting side surface 13322 is disposed obliquely downward and rearward. When worn, the second lower connecting side surface 13322 faces a rear lower part of the user, and the second lower connecting side surface 13322 may also be referred to as the rear connecting side surface of the connecting side surface 133.

The upper connecting side surface 1331, the lower connecting side surface 1332, the front connecting side surface 1333, and other side surfaces may also be curved surfaces or arc-shaped surfaces, and connection parts of the side surfaces may be set as arc transitions.

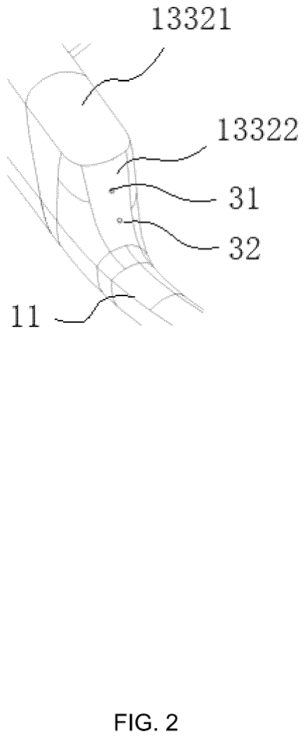

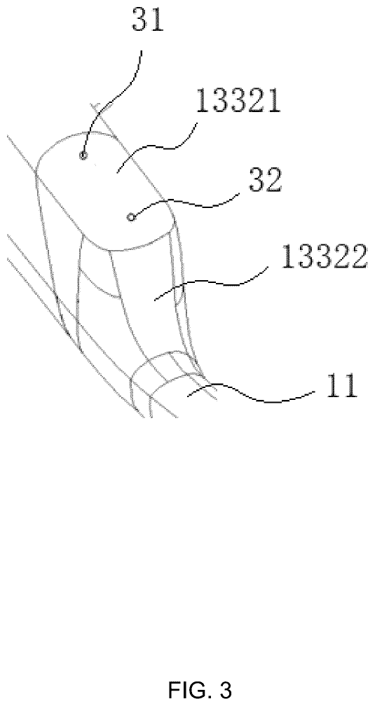

In the present embodiment, the first mounting part 13 provided with dual microphones 3 is taken as an example for description. The two microphones 3 include a first microphone 31 and a second microphone 32 that are spaced apart, and the first microphone 31 and the second microphone 32 may be disposed on any one or two surfaces of the first lower connecting side surface 13321 and the second lower connecting side surface 13322. For example, please refer to FIG. 1, the first microphone 31 is disposed on the first lower connecting side surface 13321, and the second microphone 32 is disposed on the second lower connecting side surface 13322. Alternatively, please refer to FIG. 2, the first microphone 31 and the second microphone 32 are both disposed on the first lower connecting side surface 13321. Alternatively, please refer to FIG. 3, the first microphone 31 and the second microphone 32 are both disposed on the second lower connecting side surface 13322.

In the present embodiment, the dual microphones 3 are disposed on the lower connecting side surface 1332, which firstly makes them less likely to be obstructed by the ear and more conducive to capturing sound from in front of the user, and secondly, the lower placement of the dual microphones 3 reduces the risk of clogging by dust accumulation and, particularly in rainy conditions, mitigates the possibility of water ingress.

In the present embodiment, when the bone conduction hearing aid device provides acoustic feedback to the hearing-impaired patient, vibration of the speaker 2 will inevitably be transmitted to the first mounting part 13. The vibration of the first mounting part 13 will cause interference to the sound pickup of the microphone 3 of the first mounting part 13, resulting in noise in the sound pickup and increasing the possibility of howling. During the vibration of the first mounting part 13, the outer side surface 132 and the inner side surface 131 of the first mounting part 13 vibrate and generate sound waves with identical amplitude and frequency but opposite phase, thereby forming a dipole pair. An effect of sound wave “cancellation” is formed on the connecting side surface 133 between the outer side surface 132 and the inner side surface 131. Disposing the plurality of microphones 3 on the connecting side surface 133 of the first mounting part 13, especially disposing the plurality of microphones 3 on a symmetry plane between the inner side surface 131 and the outer side surface 132, can greatly reduce the interference of the vibration of the first mounting part 13 on the sound pickup of the microphone 3, and improve the noise reduction effect of the sound pickup of the microphone 3.

In other embodiments, the lower connecting side surface 1332 may also be a plane or a curved surface. The first microphone 31 and the second microphone 32 are disposed on the lower connecting side surface 1332. The dual microphones 3 may also be disposed at a lower narrow surface position of the first mounting part 13, which can reduce the interference of vibration on the sound pickup of the microphone 3.

In other embodiments, one or two microphones 3 may also be disposed on the upper connecting side surface 1331. Similarly, disposing the microphone 3 on the narrow surface between the inner side surface 131 and the outer side surface 132 of the first mounting part 13 can reduce the interference of vibration on the sound pickup of the microphone 3.

In one embodiment, a bone conduction hearing aid device is provided. A difference between the bone conduction hearing aid device and the foregoing embodiment lies in: a disposition of the dual microphones 3 is refined.

In the present embodiment, the dual microphones 3 are disposed on different surfaces of the lower connecting side surface 1332. A connection line of the dual microphones 3 is parallel or approximately parallel to a horizontal line when worn, so that the dual microphones 3 can obtain better forward directivity of sound pickup, thereby improving the sound pickup effect for sounds in front of the user.

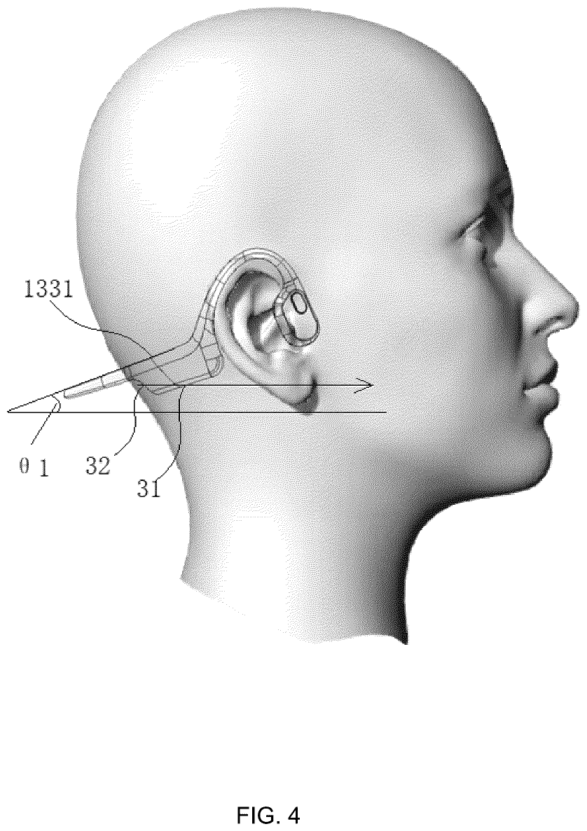

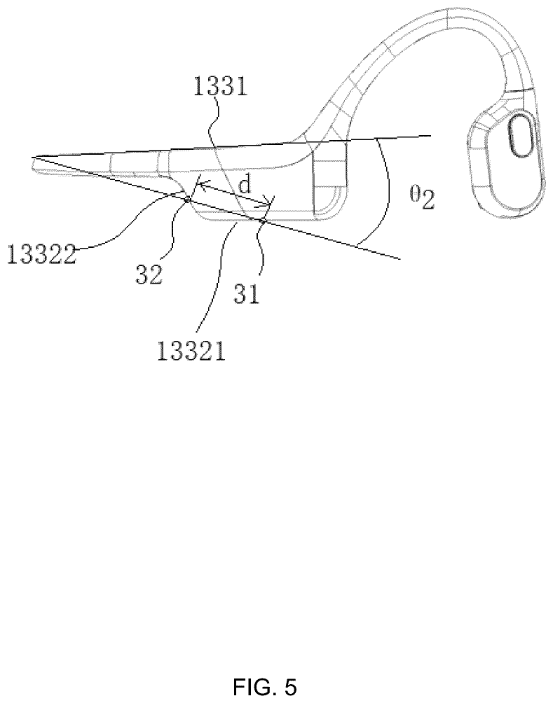

Referring to FIG. 4 and FIG. 5, the first microphone 31 is disposed on the first lower connecting side surface 13321, the second microphone 32 is disposed on the second lower connecting side surface 13322, and a first projection line of a connection line between the first microphone 31 and the second microphone 32 projected onto the outer side surface 132 intersects with a second projection line of the upper connecting side surface 1331 projected onto the outer side surface 132.

It should be noted that the intersection of the first projection line and the second projection line includes a direct intersection of the two lines, and also includes an intersection of extension lines of the two projection lines. When the upper connecting side surface 1331 is a plane perpendicular to the outer side surface 132, the second projection line is straight. When the upper connecting side surface 1331 is a curved surface perpendicular to the outer side surface 132, the second projection line is a connection line between two ends of a curve of the upper connecting side surface 1331 projected onto the outer side surface 132, and the second projection line is used to characterize an inclination of the upper connecting side surface 1331 relative to the horizontal line.

When worn, the rear hanging part 11 may sag, causing the first mounting part 13 to tilt. At this time, the first microphone 31 and the second microphone 32 are disposed on different side surfaces, so that the connection line between the first microphone 31 and the second microphone 32 is parallel or approximately parallel to the horizontal line, enabling the dual microphones 3 to achieve better forward directivity of sound pickup.

The angle between the connection line between the first microphone 31 and the second microphone 32 and the upper connecting side surface 1331 may be set based on the sagging degree of the rear hanging part 11 when worn. Generally, sagging of the rear hanging part 11 causes an incline angle θ1 of the first mounting part 13 to be 0° to −30°. Correspondingly, an angle θ2 between the first projection line of the connection line between the first microphone 31 and the second microphone 32 projected onto the outer side surface 132 and the second projection line of the upper connecting side surface 1331 projected onto the outer side surface 132 is 0° to 30°, so that the connection line between the first microphone 31 and the second microphone 32 is parallel or approximately parallel to the horizontal line when worn. For example, sagging of the rear hanging part 11 causes the incline angle θ1 of the first mounting part 13 to be −30°. Correspondingly, the angle θ2 between the first projection line of the connection line between the first microphone 31 and the second microphone 32 projected onto the outer side surface 132 and the second projection line of the upper connecting side surface 1331 projected onto the outer side surface 132 is 30°. The angle between the first projection line of the connection line between the first microphone 31 and the second microphone 32 projected onto the outer side surface 132 and the second projection line of the upper connecting side surface 1331 projected onto the outer side surface 132 is opposite in direction and equal in magnitude to the incline angle of the first mounting part 13, so that the connection line between the first microphone 31 and the second microphone 32 is parallel or approximately parallel to the horizontal line when worn.

In other embodiments, the angle θ2 between the first projection line of the connection line between the first microphone 31 and the second microphone 32 projected onto the outer side surface 132 and the second projection line of the upper connecting side surface 1331 projected onto the outer side surface 132 is 0° to 60°, which can adapt to a situation where the sagging degree of the rear hanging part 11 is greater when worn, thereby ensuring that the connection line between the first microphone 31 and the second microphone 32 is parallel or approximately parallel to the horizontal line when worn.

In one embodiment, a bone conduction hearing aid device is provided. A difference between the bone conduction hearing aid device and the foregoing embodiment lies in: a disposition of the dual microphones 3.

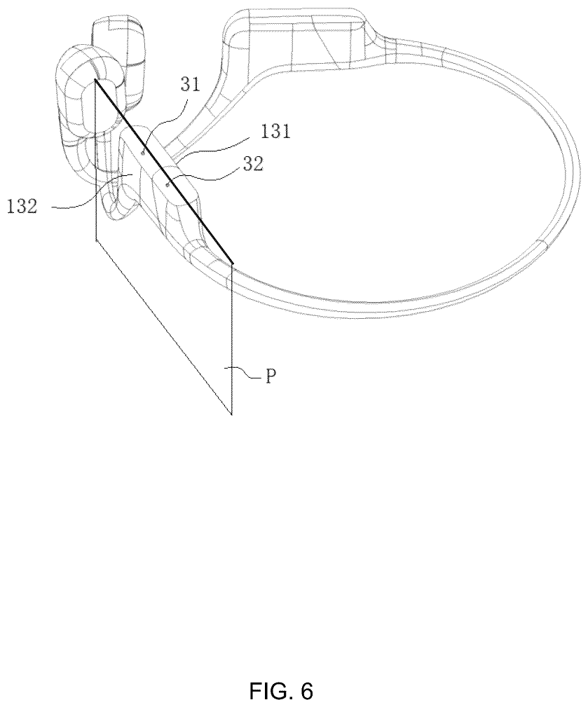

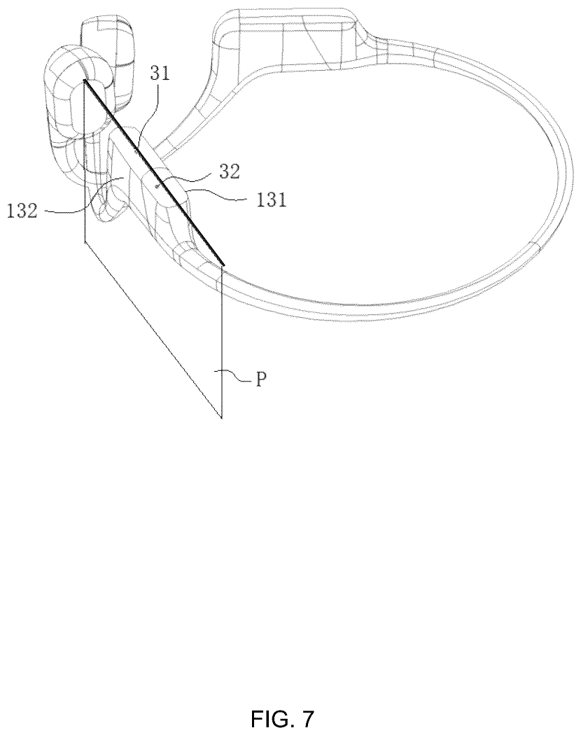

Referring to FIG. 6 and FIG. 7, in this embodiment, the dual microphones 3 are located at a position offset outward from a symmetry plane P between the inner side surface 131 and the outer side surface 132. The symmetry plane P is a middle plane between the inner side surface 131 and the outer side surface 132, and the inner side surface 131 and the outer side surface 132 are respectively at a same distance from the symmetry plane P.

When the bone conduction hearing aid device is worn, the inner side surface 131 vibrates and generates sound waves. The sound waves may not only be directly transmitted to the connecting side surface 133, but also be transmitted to the user's head and reflected to the connecting side surface 133. Therefore, in practice, the sound waves generated by the inner side surface 131 at the connecting side surface 133 are a superposition of two sound waves. Thus, on the symmetry plane P, the sound waves generated by the inner side surface 131 are slightly greater than the sound waves generated by the outer side surface 132, causing a vibration cancellation surface between the inner side surface 131 and the outer side surface 132 to be located at a position offset from the symmetry plane P between the inner side surface 131 and the outer side surface 132 and close to the outer side surface 132. Based on this analysis, the dual microphones 3 are disposed on the lower connecting side surface 1332 and at a position offset outward relative to the symmetry plane P, that is, distances between the dual microphones 3 and the outer side surface 132 are less than distances between the dual microphones 3 and the inner side surface 131, and the dual microphones 3 are closer to the outer side surface 132 than to the inner side surface 131. A Distance between the first microphone 31 and the symmetry plane and a distance between the second microphone 32 and the symmetry plane are in a range of 0 mm to 5 mm. For example, the first microphone 31 is located on the symmetry plane P, a distance between the first microphone 31 and the symmetry plane P is 0 mm, the second microphone 32 is disposed at a position offset outward relative to the symmetry plane P, and a distance between the second microphone 32 and the symmetry plane P is 5 mm.

With such a configuration, the dual microphones 3 are located on a real vibration cancellation surface between the inner side surface 131 and the outer side surface 132, which can maximize the elimination of interference of vibration on the dual microphones 3.

In other embodiments, the first microphone 31 is disposed on the lower connecting side surface 1332 and located on the symmetry plane P between the inner side surface 131 and the outer side surface 132, and the second microphone 32 is disposed on the lower connecting side surface 1332 and is closer to the outer side surface 132 than to the inner side surface 131. In other words, the second microphone 32 is located on the real vibration cancellation surface, and the first microphone 31 is located close to the real vibration cancellation surface, which can also effectively eliminate the interference of vibration on the dual microphones 3.

In one embodiment, a bone conduction hearing aid device is provided. A difference between the bone conduction hearing aid device and the foregoing embodiment lies in: a disposition of the microphones 3 is different.

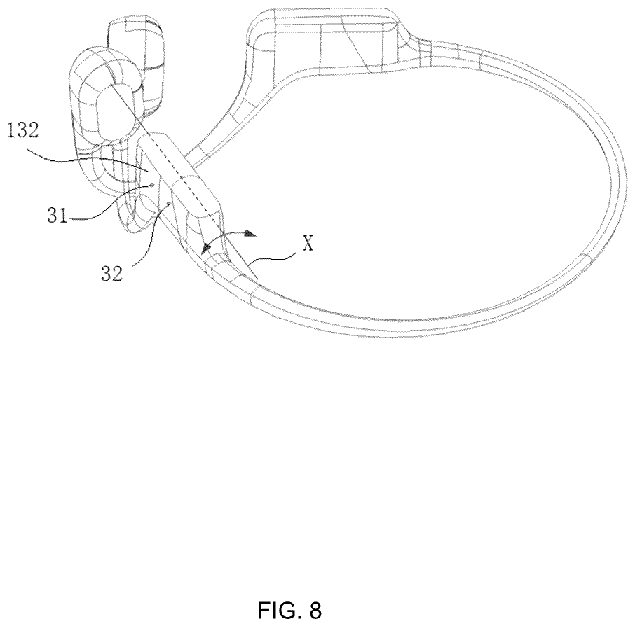

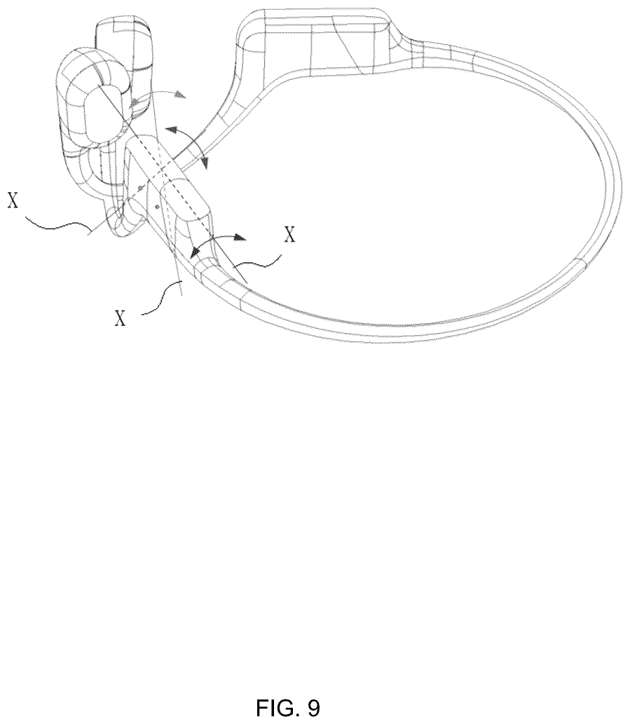

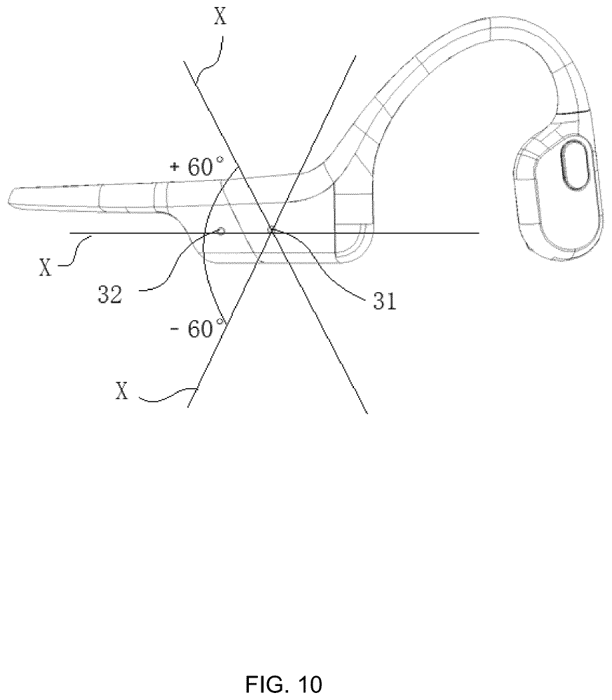

Referring to FIG. 8 to FIG. 10, in this embodiment, the plurality of microphones 3 are disposed on the outer side surface 132 of the first mounting part 13, and a connection line of the plurality of microphones 3 is parallel or approximately parallel to a vibration axis X of the first mounting part 13, so that the plurality of microphones 3 are subjected to vibration interference with the same amplitude, phase, and frequency, and vibration interference on the dual microphones 3 may be eliminated by a relatively simple algorithm, thereby improving a noise reduction effect of sound pickup.

The outer side surface 132 may also be provided with the first microphone 31 and the second microphone 32 spaced apart from each other, and the dual microphones 3 are disposed on the outer side surface 132.

The first mounting part 13 is connected to the second mounting part 14 via the ear hanging part 12. The second mounting part 14 is mounted with a vibration source speaker 2. Vibration generated by the speaker 2 is transmitted to the first mounting part 13 via the ear hanging part 12, forming vibration along the vibration axis X inside the first mounting part 13, and the vibration axis X inside the first mounting part 13 is located on or close to the symmetry plane P between the outer side surface 132 and the inner side surface 131.

The connection line between the first microphone 31 and the second microphone 32 is parallel to the symmetry plane P between the outer side surface 132 and the inner side surface 131, so that the connection line between the first microphone 31 and the second microphone 32 is parallel to the vibration axis X of the first mounting part 13.

In this embodiment, the plurality of microphones 3 are disposed on the outer side surface 132 of the first mounting part 13, and the connection line of the plurality of microphones 3 is parallel to the vibration axis X inside the first mounting part 13. With such a configuration, the plurality of microphones 3 are subjected to vibration interference with the same amplitude, phase, and frequency, and vibration interference on the dual microphones 3 may be eliminated by a relatively simple algorithm, which can also improve the noise reduction effect of sound pickup.

In one embodiment, a bone conduction hearing aid device is provided. A difference between the bone conduction hearing aid device and the foregoing embodiment lies in: a disposition of the plurality of microphones 3 is different.

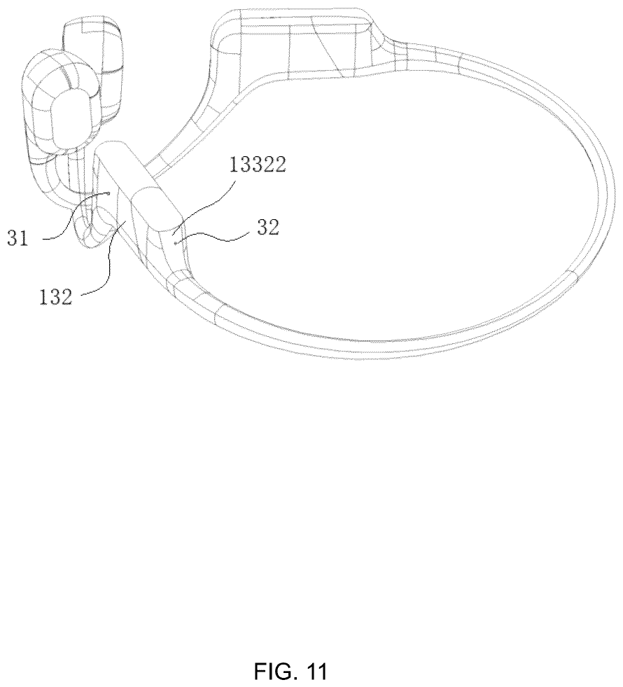

Referring to FIG. 11, in this embodiment, the plurality of microphones 3 are disposed on different side surfaces of the first mounting part 13. For example, the first microphone 31 is disposed on the outer side surface 132 of the first mounting part 13, and the second microphone 32 is disposed on the connecting side surface 133 of the first mounting part 13. The first microphone 31 and the second microphone 32 are located on different side surfaces of the first mounting part 13, which can increase the difference in sound pickup between the first microphone 31 and the second microphone 32, so as to achieve a better noise reduction effect.

The first microphone 31 is located on the outer side surface 132 close to the front connecting side surface 1333, and the second microphone 32 may be disposed on the first lower connecting side surface 13321 or the second lower connecting side surface 13322. In particular, when the second microphone 32 is disposed on the second lower connecting side surface 13322, a distance between the first microphone 31 and the second microphone 32 may be greater, and the first microphone 31 and the second microphone 32 can form a greater difference in sound pickup, to achieve a better noise reduction effect.

In this embodiment, the plurality of microphones 3 are disposed on different side surfaces of the first mounting part 13, which can increase the difference in sound pickup of the plurality of microphones 3, so as to achieve a better noise reduction effect.

In one embodiment, a bone conduction hearing aid device is provided. Based on the bone conduction hearing aid device in the above embodiment, an angle of inclination of a connection line between two microphones is defined.

In one embodiment, due to variations in the structure of the ear hanging part 12 and its bending state when worn, a third projection line of the vibration axis X generated within the first mounting part 13 projected onto the outer side surface 132 intersects with the second projection line of the upper connecting side surface 1331 of the first mounting part 13 projected onto the outer side surface 132. An angle between the third projection line and the second projection line is in a range of +60° to −60°.

The angle between the first projection line of the connection line between the first microphone 31 and the second microphone 32 projected onto the outer side surface 132 and the second projection line of the upper connecting side surface 1331 projected onto the outer side surface 132 is in a range of +60° to −60°, that is, the connection line between the first microphone 31 and the second microphone 32 is disposed obliquely, so that the first projection line of the connection line between the first microphone 31 and the second microphone 32 projected onto the outer side surface 132 may be parallel to the third projection line of the vibration axis X inside the first mounting part 13 projected onto the outer side surface 132, and thus the first microphone 31 and the second microphone 32 are subjected to vibration on the same amplitude, phase, and frequency, and vibration interference on the dual microphones 3 may be eliminated by a relatively simple algorithm, thereby improving the noise reduction effect of sound pickup.

In other embodiments, the rear hanging part 11 may sag when worn, and the sagging causes the first mounting part 13 to incline relative to the horizontal line by 0° to −30°. Therefore, preferably, considering that an angle between a direction of the two microphones and the horizontal line is not too large after wearing and sagging, and allowing the connection line of the two microphones 3 to be as close as possible to the vibration axis X, the angle between the first projection line of the connection line between the first microphone 31 and the second microphone 32 projected onto the outer side surface 132 and the second projection line of the upper connecting side surface 1331 projected onto the outer side surface 132 may be in a range of +60° to −30°, and the first projection line of the connection line between the first microphone 31 and the second microphone 32 projected onto the outer side surface 132 is correspondingly inclined and adapted, so that the first projection line of the connection line between the first microphone 31 and the second microphone 32 projected onto the outer side surface 132 is parallel or approximately parallel to the third projection line of the vibration axis X inside the first mounting part 13 projected onto the outer side surface 132.

It should be noted that the angle between the first projection line of the connection line between the first microphone 31 and the second microphone 32 projected onto the outer side surface 132 and the second projection line of the upper connecting side surface 1331 projected onto the outer side surface 132 is a value in the range of +60° to −30°, and the value may be set correspondingly based on the vibration axis X generated when the bone conduction hearing aid device is worn.

In this embodiment, the first projection line of the connection line between the first microphone 31 and the second microphone 32 projected onto the outer side surface 132 is parallel to the third projection line of the vibration axis X inside the first mounting part 13 projected onto the outer side surface 132. With such a configuration, the plurality of microphones 3 are subjected to vibration interference with the same amplitude, phase, and frequency, and vibration interference on the dual microphones 3 may be eliminated by a relatively simple algorithm, which can also improve the noise reduction effect of sound pickup.

In a preferred embodiment, the angle between the first projection line of the connection line between the first microphone 31 and the second microphone 32 projected onto the outer side surface 132 and the second projection line of the upper connecting side surface 1331 projected onto the outer side surface 132 may be in a range of +30° to −30°, and the first projection line of the connection line between the first microphone 31 and the second microphone 32 projected onto the outer side surface 132 is parallel to the third projection line of the vibration axis X inside the first mounting part 13 projected onto the outer side surface 132, which is relatively easy to achieve interference elimination and can improve the noise reduction effect of sound pickup.

In other embodiments, the rear hanging part 11 of the bone conduction hearing aid device sags naturally under the influence of gravity when worn, causing the first mounting part 13 to incline. At this time, the first projection line of the connection line between the first microphone 31 and the second microphone 32 projected onto the outer side surface 132 and the second projection line of the upper connecting side surface 1331 projected onto the outer side surface 132 are set to intersect, so that the first projection line of the connection line between the first microphone 31 and the second microphone 32 projected onto the outer side surface 132 is parallel or approximately parallel to the horizontal line, enabling the dual microphones 3 to achieve better forward directivity for sound pickup, and the first projection line of the connection line between the first microphone 31 and the second microphone 32 projected onto the outer side surface 132 may be closer to being parallel to the third projection line of the vibration axis X of the first mounting part 13 projected onto the outer side surface 132, to improve the noise reduction effect.

An angle value between the first projection line of the connection line between the first microphone 31 and the second microphone 32 projected onto the outer side surface 132 and the second projection line of the upper connecting side surface 1331 projected onto the outer side surface 132 is set based on the sagging degree of the rear hanging part 11 when worn. Generally, sagging of the rear hanging part 11 causes the first mounting part 13 to incline by 0° to −30°. Correspondingly, the angle between the connection line between the first microphone 31 and the second microphone 32 and the upper connecting side surface 1331 is 0° to 30°, so that the first projection line of the connection line between the first microphone 31 and the second microphone 32 projected onto the outer side surface 132 is parallel or approximately parallel to the horizontal line when worn. For example, the sagging of the rear hanging part 11 causes the first mounting part 13 to incline by −30°. Correspondingly, the angle between the first projection line of the connection line between the first microphone 31 and the second microphone 32 projected onto the outer side surface 132 and the second projection line of the upper connecting side surface 1331 projected onto the outer side surface 132 is 30°. The angle between the first projection line of the connection line between the first microphone 31 and the second microphone 32 projected onto the outer side surface 132 and the second projection line of the upper connecting side surface 1331 projected onto the outer side surface 132 is opposite in direction and equal in magnitude to the incline angle of the first mounting part 13, so that the first projection line of the connection line between the first microphone 31 and the second microphone 32 projected onto the outer side surface 132 is parallel or approximately parallel to the horizontal line when worn.

In other embodiments, due to unavoidable scenarios, such as turning the head or walking when worn, the rear hanging part 11 inevitably sags to a greater extent in these motion scenarios. At this time, a larger angle is set between the first projection line of the connection line between the first microphone 31 and the second microphone 32 projected onto the outer side surface 132 and the second projection line of the upper connecting side surface 1331 projected onto the outer side surface 132, so that the first projection line of the connection line between the first microphone 31 and the second microphone 32 projected onto the outer side surface 132 is parallel or approximately parallel to the horizontal line, enabling the dual microphones 3 to achieve better forward directivity for sound pickup, and the first projection line of the connection line between the first microphone 31 and the second microphone 32 projected onto the outer side surface 132 may be closer to being parallel to the vibration axis X of the first mounting part 13, to improve the noise reduction effect.

The angle value between the connection line between the first microphone 31 and the second microphone 32 and the upper connecting side surface 1331 is set based on the sagging degree of the rear hanging part 11 when worn. Generally, the sagging of the rear hanging part 11 causes the first mounting part 13 to incline by −5° to −35°. Correspondingly, the angle between the first projection line of the connection line between the first microphone 31 and the second microphone 32 projected onto the outer side surface 132 and the second projection line of the upper connecting side surface 1331 projected onto the outer side surface 132 is 5° to 35°, so that the first projection line of the connection line between the first microphone 31 and the second microphone 32 projected onto the outer side surface 132 is parallel or approximately parallel to the horizontal line when worn. For example, the sagging of the rear hanging part 11 causes the first mounting part 13 to incline by −5°. Correspondingly, the angle between the first projection line of the connection line between the first microphone 31 and the second microphone 32 projected onto the outer side surface 132 and the second projection line of the upper connecting side surface 1331 projected onto the outer side surface 132 is 5°. The angle between the first projection line of the connection line between the first microphone 31 and the second microphone 32 projected onto the outer side surface 132 and the second projection line of the upper connecting side surface 1331 projected onto the outer side surface 132 is opposite in direction and equal in magnitude to the incline angle of the first mounting part 13, so that the first projection line of the connection line between the first microphone 31 and the second microphone 32 projected onto the outer side surface 132 is parallel or approximately parallel to the horizontal line when worn.

In one embodiment, a bone conduction hearing aid device is provided. Based on the bone conduction hearing aid device of the foregoing embodiment, a distance between the dual microphones 3 is defined.

A distance between the first microphone 31 and the second microphone 32 may be set based on sound pickup needs. Generally, a distance d between the first microphone 31 and the second microphone 32 may be set to a range of 2 mm to 45 mm, wherein a preferred range is 2 mm to 30 mm. For example, the distance d between the first microphone 31 and the second microphone 32 is 2 mm, 10 mm, or 30 mm. This distance is conducive to joint computational processing of the dual microphones 3, making it easier to eliminate echo, suppress noise, etc., at an algorithm level, and thereby improving the noise reduction effect of sound pickup of the dual microphones 3.

The foregoing description applies specific examples to expound the present disclosure, which are only used to help understand the present disclosure and are not intended to limit the present disclosure. For those skilled in the art to which the present disclosure pertains, based on the idea of the present disclosure, several simple deductions, modifications, or replacements may also be made.

1. A bone conduction hearing aid device, comprising:
a support structure including a rear hanging part, ear hanging parts, first mounting parts, and second mounting parts, wherein two ends of the rear hanging part are respectively connected to one first mounting part, and each of the first mounting parts is connected to one second mounting part via one ear hanging part; the rear hanging part is configured to be worn on a rear side of a user's head, and each of the ear hanging parts is configured to be worn on an upper part of the user's ear; each of the first mounting parts includes an inner side surface facing the user when worn, an outer side surface facing away from the user when worn, and a connecting side surface connecting the inner side surface and the outer side surface;
a speaker mounted in the second mounting part, wherein the speaker is configured to play a hearing aid sound signal;
a plurality of microphones disposed on the connecting side surface, wherein the plurality of microphones are configured to receive a sound signal and convert the sound signal into an electric signal.

2. The bone conduction hearing aid device according to claim 1, wherein the plurality of microphones include at least a first microphone and a second microphone, and the first microphone and the second microphone are spaced apart.

3. The bone conduction hearing aid device according to claim 2, wherein the connecting side surface includes an upper connecting side surface facing upward when worn and a lower connecting side surface facing downward or rearward when worn, and the first microphone and the second microphone are disposed on the lower connecting side surface.

4. The bone conduction hearing aid device according to claim 3, wherein the lower connecting side surface includes a first lower connecting side surface and a second lower connecting side surface having an angle therebetween, an angle between the first lower connecting side surface and the upper connecting side surface is less than an angle between the second lower connecting side surface and the upper connecting side surface, the second lower connecting side surface faces away from the second mounting part, the first microphone is disposed on the first lower connecting side surface, and the second microphone is disposed on the second lower connecting side surface.

5. The bone conduction hearing aid device according to claim 3, wherein the lower connecting side surface includes a first lower connecting side surface and a second lower connecting side surface having an angle therebetween, and the first microphone and the second microphone are disposed on the first lower connecting side surface, or the first microphone and the second microphone are disposed on the second lower connecting side surface.

6. The bone conduction hearing aid device according to claim 3, wherein a symmetry plane is defined between the outer side surface and the inner side surface, and the first microphone and the second microphone are located outside the symmetry plane and/or on the symmetry plane.

7. The bone conduction hearing aid device according to claim 6, wherein the first microphone and/or the second microphone located outside the symmetry plane are closer to the symmetry plane than the outer side surface.

8. The bone conduction hearing aid device according to claim 6, wherein a distance between the first microphone and the symmetry plane and/or a distance between the second microphone and the symmetry plane are in a range of 0 mm to 5 mm.

9. The bone conduction hearing aid device according to claim 3, wherein a first projection line of a connection line between the first microphone and the second microphone projected onto the outer side surface is inclined relative to a second projection line of the upper connecting side surface projected onto the outer side surface.

10. The bone conduction hearing aid device according to claim 9, wherein an angle between the first projection line and the second projection line is in a range of 0° to 60°.

11. The bone conduction hearing aid device according to claim 10, wherein the angle between the first projection line and the second projection line is in a range of 0° to 30°.

12. The bone conduction hearing aid device according to claim 9, wherein an angle between the first projection line and the second projection line is in a range of 5° to 65°.

13. The bone conduction hearing aid device according to claim 12, wherein the angle between the first projection line and the second projection line is in a range of 5° to 35°.

14. The bone conduction hearing aid device according to claim 9, wherein the first projection line is parallel to a horizontal line when the bone conduction hearing aid device is worn.

15. The bone conduction hearing aid device according to claim 2, wherein a distance between the first microphone and the second microphone is in a range of 2 mm to 45 mm.

16. A bone conduction hearing aid device, comprising:
a support structure including a rear hanging part, ear hanging parts, first mounting parts, and second mounting parts, wherein two ends of the rear hanging part are respectively connected to one first mounting part, and each of the first mounting parts is connected to one second mounting part via one ear hanging part; the rear hanging part is configured to be worn on a rear side of a user's head, and each of the ear hanging parts is configured to be worn on an upper part of the user's ear; each of the first mounting parts includes an inner side surface facing the user when worn, an outer side surface facing away from the user when worn, and a connecting side surface connecting the inner side surface and the outer side surface;
a speaker mounted in the second mounting part, wherein the speaker is configured to play a hearing aid sound signal;
a plurality of microphones disposed on the connecting side surface and the outer side surface, wherein the plurality of microphones are configured to receive a sound signal and convert the sound signal into an electric signal.

17. The bone conduction hearing aid device according to claim 16, wherein the plurality of microphones include at least a first microphone and a second microphone, and the first microphone and the second microphone are spaced apart.

18. The bone conduction hearing aid device according to claim 17, wherein the connecting side surface includes an upper connecting side surface facing upward when worn and a lower connecting side surface facing downward or rearward when worn, the first microphone is disposed on the lower connecting side surface, and the second microphone is disposed on the outer side surface.

19-25. (canceled)

26. A bone conduction hearing aid device, comprising:
a support structure including a rear hanging part, ear hanging parts, first mounting parts, and second mounting parts, wherein two ends of the rear hanging part are respectively connected to one first mounting part, and each of the first mounting part is connected to one second mounting part via one ear hanging part; the rear hanging part is configured to be worn on a rear side of a user's head, and each of the ear hanging parts is configured to be worn on an upper part of the user's ear; each of the first mounting parts includes an inner side surface facing the user when worn, an outer side surface facing away from the user when worn, and a connecting side surface connecting the inner side surface and the outer side surface;
a speaker mounted in the second mounting part, wherein the speaker is configured to play a hearing aid sound signal;
a plurality of microphones disposed on the outer side surface, wherein the plurality of microphones are located on a straight line; and the plurality of microphones are configured to receive a sound signal and convert the sound signal into an electric signal.

27. The bone conduction hearing aid device according to claim 26, wherein a symmetry plane is defined between the outer side surface and the inner side surface, and the straight line is parallel to the symmetry plane.

28-33. (canceled)
